(19) United States
(12) Patent Application Publication
(10) Pub. No.: US 2017/0344943 A1
(43) Pub. Date: Nov. 30, 2017

(54) INCENTIVIZED ADJUSTMENT OF OPTIMAL DELIVERY ROUTE

(71) Applicant: INTERNATIONAL BUSINESS MACHINES CORPORATION, Armonk, NY (US)

(72) Inventors: Bradley C. Herrin, Marina Del Ray, CA (US); Morris Johnson, Cary, NC (US); Matthew McGuigan, San Francisco, CA (US); Jarett Stein, Bryn Mawr, PA (US)

(21) Appl. No.: 15/164,260

(22) Filed: May 25, 2016

(51) Int. Cl. G06Q 10/08; G06Q 30/02

(52) U.S. Cl. CPC G06Q 10/08355; G06Q 30/0217

(57) ABSTRACT

Methods, computer program products, and systems are presented. The methods include, for instance: adjusting a delivery route by use of incentives. In one embodiment the adjusting may include: based on constraints for entities, generating a delivery route that optimizes a target criteria based on criteria constraints of entities subscribing to a routing optimization system; receiving a request to change the delivery route from a requesting entity of the entities; generating a new route by use of a new set of constrains comprising additional constraints formulated from the request; analyzing the new route for impact to the entities on the criteria constraints; calculating the incentives respective to the entities based on the impact and characterization of the requesting entity; communicating the incentives and the new route amongst the entities and deploy the new route once accepted by all of the entities.

### TECHNICAL FIELD

The present disclosure relates to cognitive computing and logistics, and more particularly, to methods, computer program products, and systems for automated optimization and adjustment of a delivery route.

### BACKGROUND

In commercial distribution of goods, sellers, buyers, and shippers of such goods are to operate within the limitations of factors such as respective business interests and operational capacity, critical dates based on seasonal items and shelf life of goods, labor laws, transportation and safety regulations, and so on. Accordingly, logistics in delivery scheduling have become more sophisticated and automated to generate a more cost effective delivery schedules while the parties involved in the distribution may operate within the limitations of the aforementioned factors. Online shopping center delivery, cargo services, express courier services, and various kind of shipping and trucking companies utilize logistics based on real-time analytics of dynamic environments, mobile communication, and cloud-based solutions for routing optimization.

### SUMMARY

The shortcomings of the prior art are overcome, and additional advantages are provided, through the provision, in one aspect, of a method. The method for adjusting a delivery route by use of incentives includes, for example: storing, by one or more processor, the delivery route in a routing optimization database by a routing optimization system including a routing engine and the routing optimization database including a first set of constraints, the delivery route for two or more entities based on the first set of constraints respectively associated with the entities, wherein the entities represented by respective entity program subscribe to a routing service provided by the routing optimization system running on a computer, wherein the delivery route is optimized for a target criteria determined as a function of one or more criteria constraints selected from the first set of constraints; receiving, by the one or more processor, via a communication channel, a request to change the delivery route from a first entity program corresponding to a requesting entity of the entities; updating the routing optimization database with a new set of constraints including the first set of constraints, and one or more additional constraints and zero or more replacement constraints as formulated corresponding to the request; storing, by the one or more processor, in the routing optimization database, a new route for the entities as generated based on the new set of constraints; storing, by the one or more processor, in the routing optimization database, respective impact measurement for each entity of the entities, as respectively affected by the new route in terms of the criteria constraints, as analyzed by the routing engine; storing, by the one or more processor, in the routing optimization database, respective incentive amount for the each entity to be paid by the requesting entity to the each entity on condition of accepting the new route, as calculated by the routing engine; receiving, by the one or more processor, respective response from the each entity affirming that the each entity accepts the new route and the respective incentive amount, responsive to sending the each entity the new route and the respective incentive amount, subsequent to agreeing by the requesting entity to pay the respective incentive amount to the each entity on the condition; and, storing, by the one or more processor, the new route in the routing optimization database for deploying the new route for future deliveries performed by the entities of the routing optimization system.

Additional features are realized through the techniques set forth herein. Other embodiments and aspects, including but not limited to computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts an incentivized route adjustment system 100, in accordance with one or more embodiments set forth herein;

FIG. 2 depicts representative data elements stored in the routing optimization database of the routing optimization system in FIG. 1, in accordance with one or more embodiments set forth herein;

FIG. 3 depicts a flowchart for the routing engine of the routing optimization system in FIG. 1, in accordance with one or more embodiments set forth herein;

FIG. 4A depicts a detailed flowchart for generating the initial route, as performed in block 310 of FIG. 3 by the routing engine, in accordance with one or more embodiments set forth herein;

FIG. 4B depicts a detailed flowchart for adjusting the initial route, as performed in block 330 of FIG. 3 by the routing engine 130, in accordance with one or more embodiments set forth herein;

FIG. 4C depicts a detailed flowchart for checking acceptance of the new route by respective entities, as performed in block 340 of FIG. 3 by the routing engine 130, in accordance with one or more embodiments set forth herein;

FIG. 5 depicts an example for a group of entities with respective ordering/shipping system data, wherein the entities subscribe to one embodiment of the routing optimization system 110 of FIGS. 1, 2, 3, 4A, 4B, and 4C for optimal delivery routing and incentivized adjustment of an optimal route, in accordance with one or more embodiments set forth herein;

FIG. 6 depicts a cloud computing node according to an embodiment set forth herein;

FIG. 7 depicts a cloud computing environment according to an embodiment set forth herein; and

FIG. 8 depicts abstraction model layers according to an embodiment set forth herein.

### DETAILED DESCRIPTION

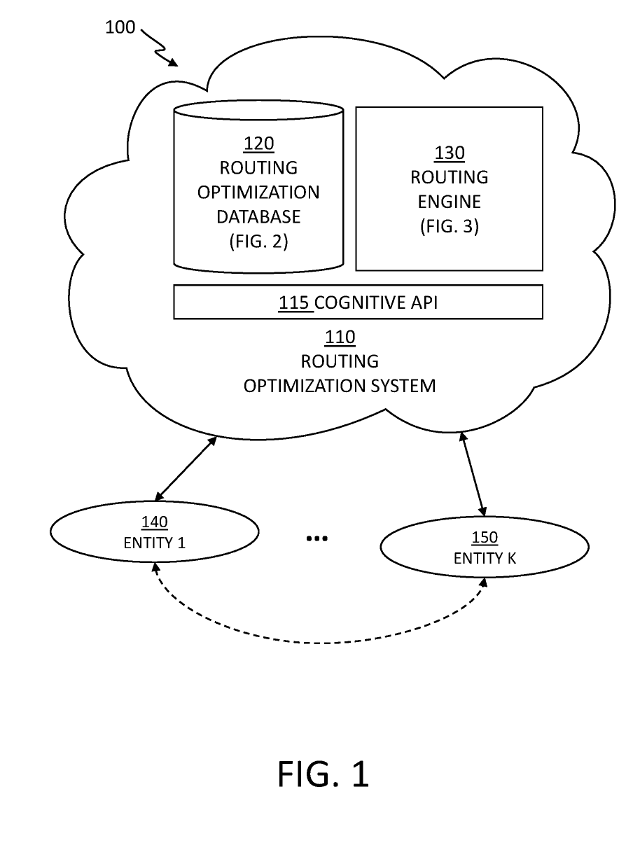

FIG. 1 depicts an incentivized route adjustment system 100, in accordance with one or more embodiments set forth herein.

The incentivized route adjustment system 100 includes a routing optimization system 110 and two or more entities 140, 150 communicating with the routing optimization system 110.

The routing optimization system 110 is a provider of a routing service generating delivery routes that optimizes a measurement for a predefined category for the two or more entities 140, 150 that subscribe to the routing service by the routing optimization system 110. The routing service is provided for a fee to subscribers, and may be implemented by use of a cloud computing environment. The routing optimization system 110 includes a cognitive application program interface (API) 115, a routing optimization database 120, and a routing engine 130. The routing optimization system 110 utilizes the cognitive API 115 to communicate with respective software programs running on the two or more entities 140, 150 in requesting the respective software programs for specific data and in receiving the requested data from respective entity database of the two or more entities 140, 150 as the two or more entities 140, 150 respond to the routing optimization system 110.

Respective arrows between the routing optimization system 110 and the two or more entities 140, 150 represent the routing service provided by the routing optimization system 110 and aforementioned communication between the routing optimization system 110 and the two or more entities 140, 150.

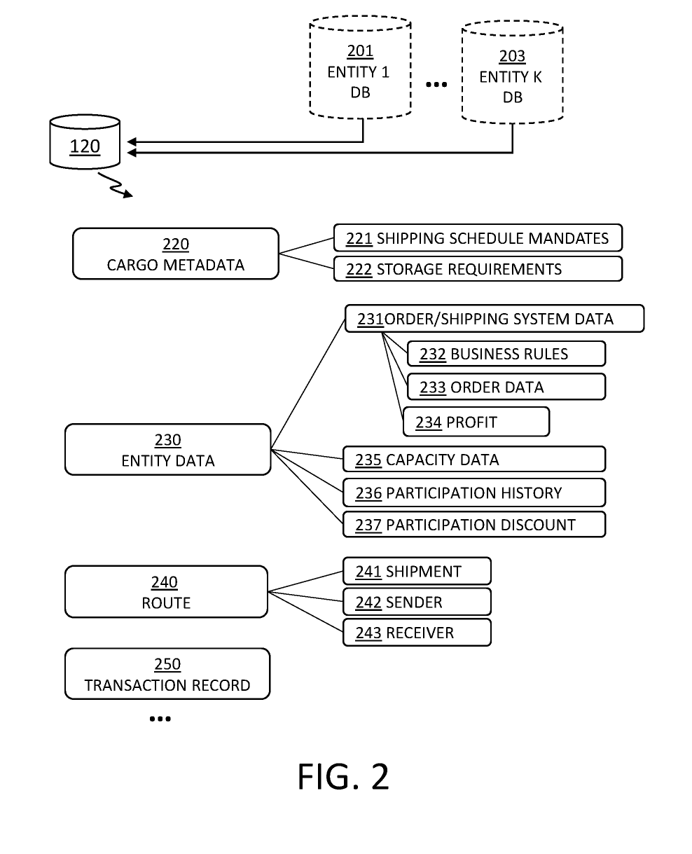

The routing optimization database 120 stores information related to the process of the routing engine 130. Examples of data stored in the routing optimization database 120 may be, but are not limited to, order data, cargo metadata, entity data, routes, transaction records, and so on. As the routing engine 130 operates based on the data stored in the routing optimization database 120, and, the routing engine 130 converts the data collected from the two or more entities 140, 150 into constraints to store in the routing optimization database 120, terms “constraints” and “data” may be used interchangeably when not distinguished in this disclosure. The routing optimization database 120 communicates with and collects relevant data from the two or more entities 140, 150 via the cognitive API 115 in building the routing optimization database 120. See FIG. 2 and corresponding description for details of the routing optimization database 120.

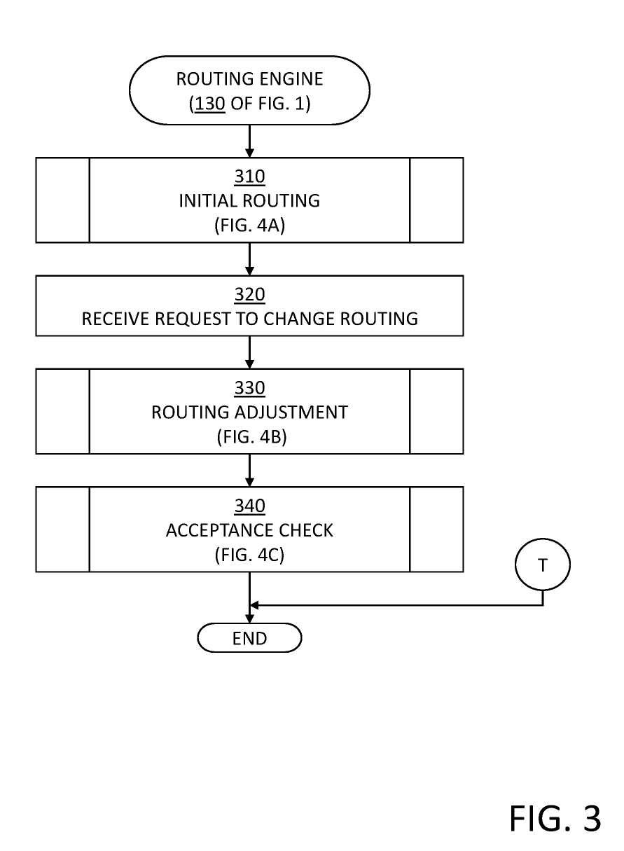

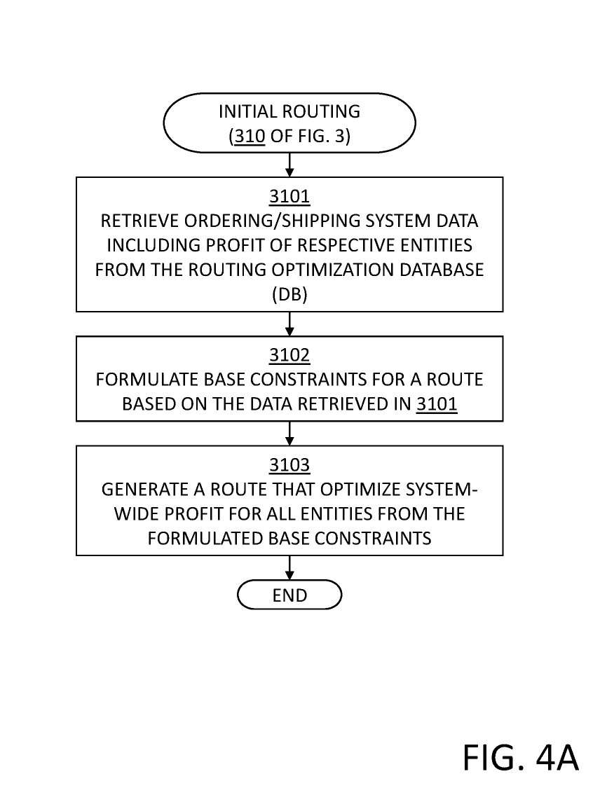

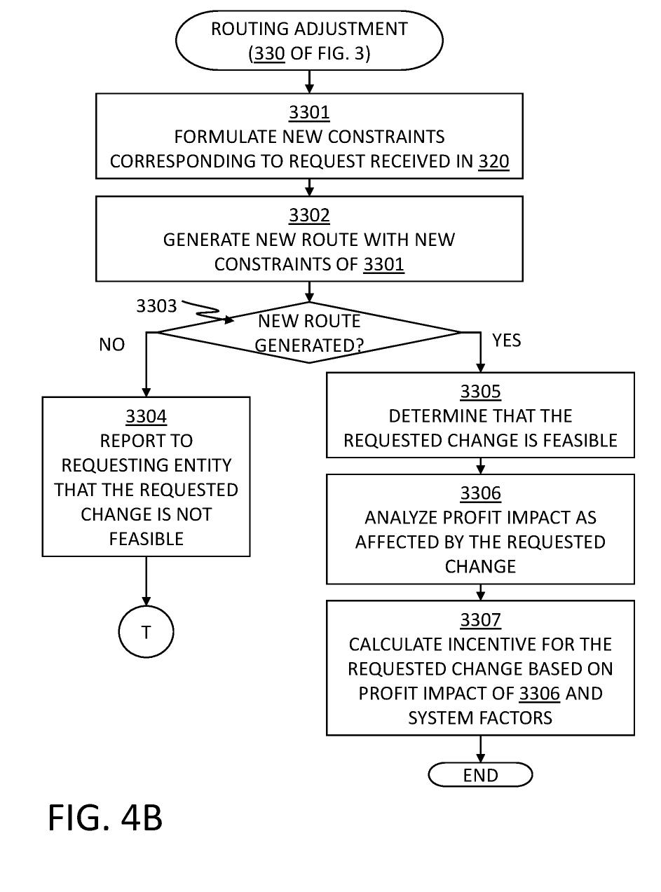

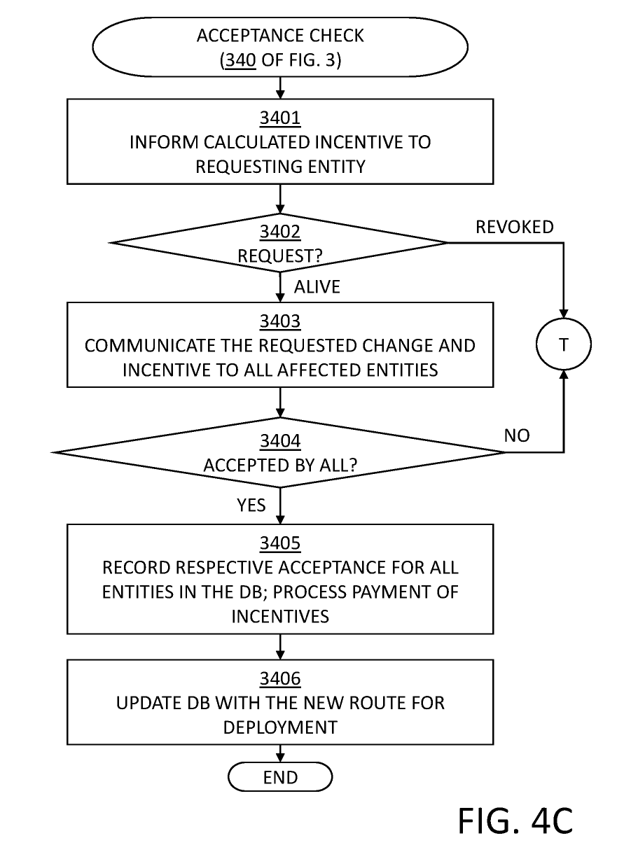

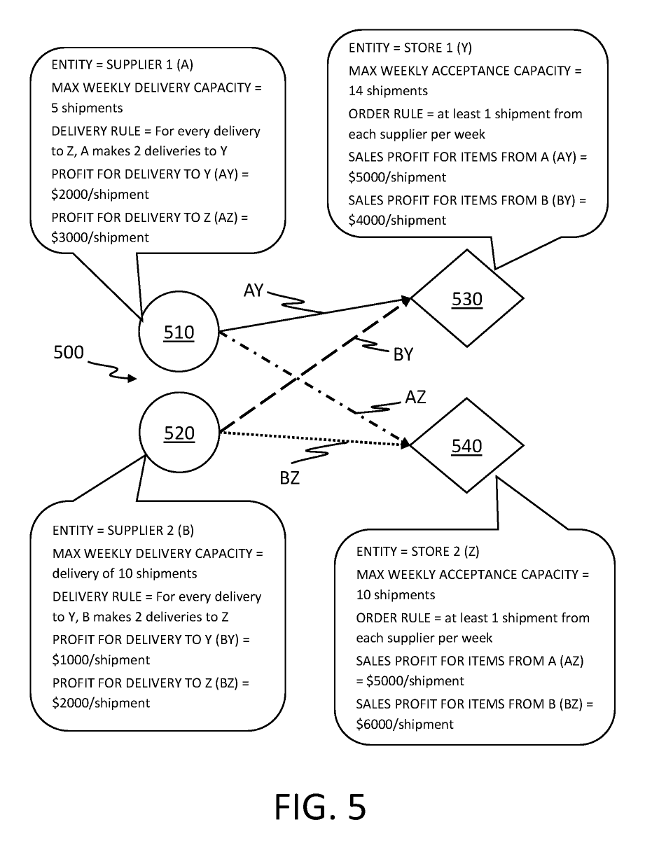

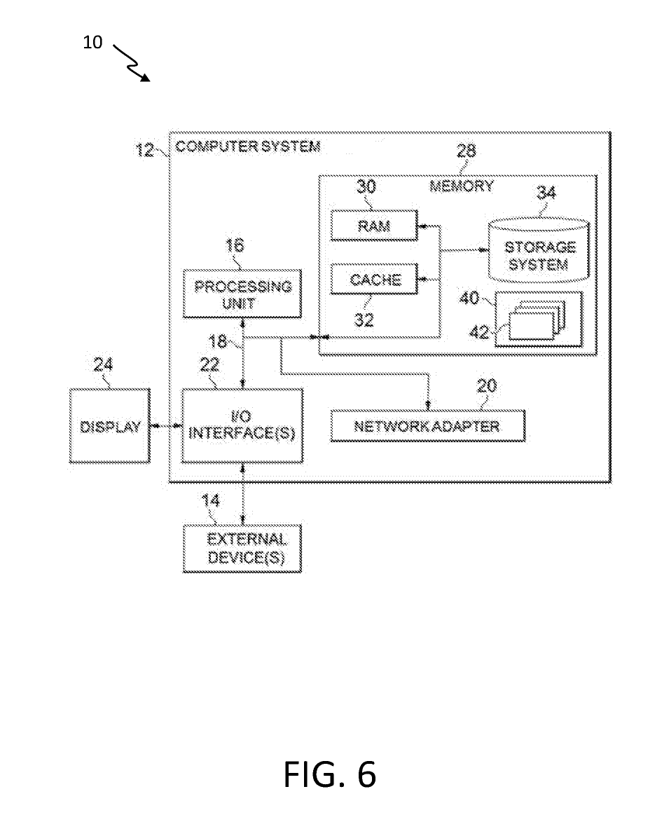

The routing engine 130 processes information stored in the routing optimization database 120 and generates a delivery route that optimizes the measurement for the predefined category. In one embodiment of the present disclosure, the predefined category is Profit and the delivery route is generated to optimize Profit, that is, to maximize the sum of profits corresponding to each entity subscribing to the routing service of the routing optimization system 110. Wherein one of the two or more entities 140, 150 requests a change of the delivery route, the routing engine 130 generates a new delivery route optimizing Profit based on a new set of data including the request. See FIGS. 3, 4A, 4B, and 4C and corresponding description for details of the routing engine 130. Also see FIG. 5 and corresponding description for an example of the operations of the routing engine 130. In one embodiment of the present disclosure, the routing optimization system 110 and the routing engine 130 are respectively implemented as one or more program 40 and program modules 42 of FIG. 6, which run on one or more processor 16 of FIG. 6, of a computer system or a cloud computing node 12 of FIG. 6.

The two or more entities 140, 150 are subscribers of the routing service that may include, but are not limited to, a supplier selling the goods, a store buying the goods from the supplier, and a carrier transporting the goods from the supplier and the store, etc. Each entities 140, 150 has their respective business mandates and rules of operation stored in their respective databases, which are to be gathered into the routing optimization database 120 by use of the cognitive API 115 to form base constraints of the routing engine 130. Dashed arrow between Entity 1 140 and Entity K 150 represents indirection communication and interaction by use of the routing service by the routing optimization system 110 as well as the actual delivery routes by which the goods are transported.

FIG. 2 depicts representative data elements stored in the routing optimization database 120 of the routing optimization system 110 in FIG. 1, in accordance with one or more embodiments set forth herein.

The routing optimization database 120 stores data collected from respective entity databases 201, 203 of the two or more entities 140, 150 of FIG. 1 via the cognitive API 115 as described in FIG. 1. The routing optimization database 120 also stores constraints to be used by the routing engine 130 based on processing the data collected from the respective entity databases 201, 203. In one embodiment of the present disclosure, the routing optimization database 120 includes cargo metadata 220, entity data 230, a route 240, and a transaction record 250.

The cargo metadata 220 represents information on the items included in the shipment. The cargo metadata 220 includes attributes of Shipping Schedule Mandates 221 and Storage Requirements 222. Attribute Shipping Schedule Mandates 221 represents numerous dates related to shelf life of the items, and attribute Storage Requirements 222 represents required storage temperature, stacking limitation, etc. The cargo metadata 220 may further include attributes of product codes of the items, handling instructions, weight, quantity, etc. The cargo metadata 220 may be automatically uploaded to the routing optimization database as the shipment manifest is scanned at checkpoints. The cargo metadata 220 may further include shipping priority attribute for seasonal items and emergency response products, which may be automatically adjusted according to weather changes and passage of time.

The entity data 230 represents information relevant to respective entity, as collected from respective entity database, or as processed into constraints from the collected data for routing optimization purposes. The entity data 230 includes attributes of Order/Shipping System data 231, Capacity Data 235, Participation History 236, and Participation Discount 237.

Attribute Order/Shipping System data 231 includes sub-level attributes of Business Rules 232, Order Data 233, and Profit 234. Attribute Business Rules 232 represents business constraints that regulate activities of respective entity, such as contractual obligations between entities, regulatory mandates in ordering and shipping, etc. Attribute Order Data 233 represents items that the entity had ordered or the entity had been ordered to ship by other entities, including product and shipping information of the items. Attribute Profit 234 represents a profit of an entity per shipment.

Attribute Capacity Data 235 represents capacity for payment, availability of delivery, or the size of warehouse specifying a largest shipment that is acceptable for the entity, based on a type of the entity. Attribute Participation History 236 represents how often the entity had accepted a requested adjustment to the current route in the past. Attribute Participation Discount 237 represents a percentage of the calculated that may be discounted for an entity proportional to the participation rate as recorded in the attribute Participation History 236. See FIG. 5 and corresponding description for usage of the attributes Participation History 236 and Participation Discount 237 in calculating the incentive in one embodiment of the present disclosure.

The route 240 represents an optimal route for delivery as calculated by the routing engine. The route 240 includes attributes of Shipment 241, Sender 242, and Receiver 243. Attribute Shipment 241 represents an order to be delivered between a pair of entities. Attribute Sender 242 represents a first entity of the pair of entities that delivers the shipment as specified in attribute Shipment 241. Attribute Receiver 243 represents a second entity of the pair of entities that requests the shipment as specified in attribute Shipment 241.

The transaction record 250 represents information regarding requests to change a route in use and results associated with the respective requests, such as whether or not a new route corresponding to a request had been generated, whether the generated new route had been accepted as a new route or rejected, etc. In one embodiment of the present disclosure, the transaction record 250 is generated as a collection of attribute Participation History 236 for all entities represented in the routing optimization database 120.

FIG. 3 depicts a flowchart for the routing engine 130 of the routing optimization system 110 in FIG. 1, in accordance with one or more embodiments set forth herein.

In block 310, the routing engine 130 generates an initial route from the data stored in the routing optimization database 120 for the two or more entities subscribing to the routing service. The initial route is deployed for deliveries amongst the two or more entities until a request affecting the initial route is received by the routing engine 130. See FIG. 4A and corresponding description for details of block 310 generating the initial route. Then the routing engine 130 proceeds with block 320.

In block 320, the routing engine 130 receives a request to make change to the initial route from a requesting entity. In one embodiment of the present disclosure, the request is formulated into a new set of constraints and stored in the routing optimization database 120. Then the routing engine 130 proceeds with block 330.

In block 330, the routing engine 130 adjusts the initial route by creating a new route based on the data of the routing optimization database 120 including the request received in block 320. In block 330, the routing engine 130 also analyzes the new route and determines incentives associated with the new route, which an entity submitted the request should pay for other entities to accept the new route. See FIG. 4B and corresponding description for details of block 330, in which the routing engine 130 adjusting the route. Then the routing engine 130 proceeds with block 340 with the generated new route and associated incentives respective to parties.

In block 340, the routing engine 130 checks if the two or more entities subscribing to the routing service of the routing optimization system 110 accept the new route and associated incentives as adjusted in block 330. See FIG. 4C and corresponding description for details of block 340 for the routing engine 130 checking acceptance of the new route and incentives by the two or more entities. The routing engine 130 completes processing the request received in block 320, whether or not the new route is deployed. The routing engine 130 may loop back to block 320 to wait for another request to change the new route, in which the new route would be in place for the route from block 3103 of FIG. 4A.

FIG. 4A depicts a detailed flowchart for generating the initial route, as performed in block 310 of FIG. 3 by the routing engine 130, in accordance with one or more embodiments set forth herein.

In block 3101, the routing engine 130 retrieves ordering/shipping system data including business rules, order data, and profit corresponding to the respective entities in the routing optimization system, from the routing optimization database. Then the routing engine 130 proceeds with block 3102.

In block 3102, the routing engine 130 formulates base constraints by use of the business rules, the order data and the profit for each delivery for the respective entities in the routing optimization system, as retrieved from the routing optimization database in block 3101. In one embodiment of the present invention, the routing engine 130 formulates the base constraints with linear programming using simplex method based on the ordering/shipping system data. See FIG. 5 and corresponding description for an example of formulating base constraints. Then the routing engine 130 proceeds with block 3103.

In block 3103, the routing engine 130 generates an optimal route that maximizes the sum of all profits gained by the respective entities based on the base constraints formulated in block 3102. In one embodiment of the present disclosure, the optimal route is represented by how many shipments are to be delivered from a supplier to a store on a weekly basis. See FIG. 5 and corresponding description for an example of the optimal route. In another embodiment of the present disclosure, the optimal route is tuned for another predefined category based on the constraints of the two or more entities. Then the routing engine 130 completes processing block 310.

FIG. 4B depicts a detailed flowchart for adjusting the initial route, as performed in block 330 of FIG. 3 by the routing engine 130, in accordance with one or more embodiments set forth herein.

In block 3301, the routing engine 130 formulates new constraints that correspond to the request to make changes to the initial route, as received in block 320 of FIG. 3. In one embodiment of the present invention, the routing engine 130 formulates the new constraints in a fashion similar to the base constraints, by use of linear programming using simplex method. See FIG. 5 and corresponding description for an example of formulating new constraints based on the request. Then the routing engine 130 proceeds with block 3302.

In block 3302, the routing engine 130 generates a new route based on the new constraints formulated in block 3301. See FIG. 5 and corresponding description for an example of generating the new route based on the new constraints. Then the routing engine 130 proceeds with block 3303.

In block 3303, the routing engine 130 determines whether or not block 3302 had resulted in the new route. If the routing engine 130 determines that the new route had not been generated, as there is no solution to satisfy the new constraints corresponding to the request for changing the initial route, then the routing engine 130 proceeds with block 3304. If the routing engine 130 determines that the new route had been generated, then the routing engine 130 proceeds with block 3305.

In block 3304, the routing engine 130 reports to the requesting entity that the requested change is not feasible such that no new route has been generated. Then the routing engine 130 terminates processing the request received in block 320 of FIG. 3.

In block 3305, the routing engine 130 determines that the requested change is feasible as the new route based on the new constraints has been generated. Then the routing engine 130 proceeds with block 3306.

In block 3306, the routing engine 130 analyzes how the new route will affect profits of respective entities. See FIG. 5 and corresponding description for an example of affected profit analysis. Then the routing engine 130 proceeds with block 3307.

In block 3307, the routing engine 130 calculates a quantity of incentive(s) the requesting entity needs to pay to affected entities respectively for accepting the changes, based on profit impact analysis of block 3306 and other factors employed in the routing optimization system. In one embodiment of the present disclosure, the requesting entity pays less incentives to the affected entity proportional to the rate of acceptance of similar changes made by other entities in the past. See FIG. 5 and corresponding description for an example of percentage incentive discount scheme based on participation history. Then the routing engine 130 completes processing block 330.

FIG. 4C depicts a detailed flowchart for checking acceptance of the new route by respective entities, as performed in block 340 of FIG. 3 by the routing engine 130, in accordance with one or more embodiments set forth herein.

In block 3401, the routing engine 130 informs the requesting entity of the incentives to be paid out to all affected entities as calculated in block 3307 to deploy the new route implementing the requested change. Optionally, the requesting entity may offer a new amount of incentive that the requesting entity is willing to pay to accommodate the new route. Then the routing engine 130 proceeds with block 3402.

In block 3402, the routing engine 130 determines whether or not the requesting entity agreed to bear the cost to make the requested change to the route to happen and to use the new route, based on the requesting entity input, or preconfigured cutoff amount. If the routing engine 130 determines that the requesting entity pursues the request with the cost of incentive payout, then the routing engine 130 proceeds with block 3403. If the routing engine 130 determines that the requesting entity revokes the request for any reason, then the routing engine 130 terminates processing the request received in block 320 of FIG. 3.

In block 3403, the routing engine 130 communicates the requested change and associated respective incentives to all affected entities, and collects the responses from the affected entities. Then the routing engine 130 proceeds with block 3404.

In block 3404, the routing engine 130 determines whether or not all the affected entities had accepted the new route as well as the associated respective incentives. If the routing engine 130 determines that all the affected entities had accepted the new route and the associated respective incentives, then the routing engine 130 proceeds with block 3405. If the routing engine 130 determines that at least one of the affected entities had not accepted the new route, then the routing engine 130 terminates processing the request received in block 320 of FIG. 3.

In block 3405, the routing engine 130 records respective acceptance for all affected entities in the routing optimization database for participation history and facilitates payment of respective incentives to all affected parties. Then the routing engine 130 proceeds with block 3406.

In block 3406, the routing engine 130 updates the routing optimization database with the new route such that the new route shall be used in place of the initial route for future deliveries. Then the routing engine 130 completes processing block 340.

FIG. 5 depicts an example 500 for a group of entities 510, 520, 530, and 540 with respective ordering/shipping system data, wherein the entities subscribe to one embodiment of the routing optimization system 110 of FIGS. 1, 2, 3, 4A, 4B, and 4C for optimal delivery routing and incentivized adjustment of an optimal route, in accordance with one or more embodiments set forth herein.

The example 500 includes four entities 510, 520, 530, and 540 subscribing to the routing optimization system 110 of FIGS. 1, 2, 3, 4A, 4B, and 4C. Entity 510 is identified as Supplier1, whose business rule is configured as the attributes of Maximum Weekly Delivery Capacity having the value of five (5) shipments, Delivery Rule directing that Supplier1 makes two (2) deliveries to Store1 for every delivery to Store2, Profit For Delivery to Store1 having the value of two thousand dollars ($2,000) per shipment, and Profit For Delivery to Store2 having the value of three thousand dollars ($3,000) per shipment. In formulating the business rule of Supplier1, letter A is assigned for Supplier1, letter Y is assigned for Store1, and letter Z is assigned for Store2. Arrow AY indicates a delivery from Supplier1 to Store1, and arrow AZ indicates delivery from Supplier1 to Store2. Respective numbers of weekly deliveries corresponding to arrows AY and AZ are calculated as part of an optimal route by the routing engine.

Entity 520 is identified as Supplier2, whose business rule is configured as the attributes of Maximum Weekly Delivery Capacity having the value of ten (10) shipments, Delivery Rule directing that Supplier2 makes two (2) deliveries to Store2 for every delivery to Store 1, Profit For Delivery to Store1 having the value of one thousand dollars ($1,000) per shipment, and Profit For Delivery to Store2 having the value of two thousand dollars ($2,000) per shipment. In formulating the business rule of Supplier2, letter B is assigned for Supplier2, and letters Y and Z are used for Store1 and Store2 as assigned earlier in formulating the business rule of Supplier1, represented as letter A. Arrow BY indicates a delivery from Supplier2 to Store1, and arrow BZ indicates delivery from Supplier2 to Store2. Respective numbers of weekly deliveries corresponding to arrows BY and BZ are calculated as part of the optimal route by the routing engine.

Entity 530 is identified as Store1, represented as letter Y in the linear equations, whose business rule is configured as the attributes of Maximum Weekly Acceptance Capacity having the value of fourteen (14) shipments, Order Rule directing that Store1 orders at least one (1) weekly shipment from each supplier, Supplier1 510 and Supplier2 520, Sales Profit For Items from Supplier1 having the value of five thousand dollars ($5,000) per shipment, and Sales Profit For Items from Supplier2 having the value of four thousand dollars ($4,000) per shipment.

Entity 540 is identified as Store2, represented as letter Z in the linear equations, whose business rule is configured as the attributes of Maximum Weekly Acceptance Capacity having the value of ten (10) shipments, Order Rule directing that Store2 orders at least one weekly shipment from each supplier, Supplier1 510 and Supplier2 520, Sales Profit For Items from Supplier1 having the value of five thousand dollars ($5,000) per shipment, and Sales Profit For Items from Supplier2 having the value of six thousand dollars ($6,000) per shipment.

Arrows AY, BY, AZ and BZ correspond to the respectively identical numbers of weekly deliveries in the optimal route as calculated by the routing engine, because each delivery has a sender, Supplier1 or Supplier2 in this embodiment, and a receiver, Store1 or Store2 in this embodiment. As noted, the optimal route is calculated to maximize the sum of profits made by all entities 510, 520, 530, and 540 subscribing to the routing optimization system. The base constraints are formulated with a set of linear equations by use of linear programming/simplex method.

In one embodiment of the present disclosure, the routing engine formulates a linear program to maximize the sum of profits as well as constraints representing the business rules for respective entities, and calculates and analyzes the optimal route by use of a commercially available tool. The optimal route also may be analyzed for adjustment feasibility, by use of the same tool. One non-limiting example of such a tool is a QuickQuant tool (QuickQuant is a mark of ALFASOFT LIMITED., a company registered in United Kingdom).

For the optimal route, the linear program is formulated as:

Maximize P=1000*B1+2000*B2+2000*A1+3000*A2+5000*Y1+4000*Y2+5000*Z1+6000*Z2,

wherein P indicates the sum of profits, B1 indicates a number of weekly deliveries that Supplier2 ships to Store1, B2 indicates a number of weekly deliveries that Supplier2 ships to Store2, A1 indicates a number of weekly deliveries that Supplier1 ships to Store1, A2 indicates a number of weekly deliveries that Supplier1 ships to Store2, Y1 indicates a number of weekly deliveries that Store1 receives from Supplier1, Y2 indicates a number of weekly deliveries that Store1 receives from Supplier2, Z1 indicates a number of weekly deliveries that Store2 receives from Supplier1, and Z2 indicates a number of weekly deliveries that Store2 receives from Supplier2. In this example, terms “delivery” and “shipment” are used interchangeably, as each delivery is presumed to deliver a shipment.

Using the variables introduced above, base constraints of Entity 520 representing Supplier2 are formulated as:

C1: B1+B2<=10;

C2: 2*B1+B2<=10,

wherein C1 represents Maximum Weekly Delivery Capacity attribute of Supplier2 having the value of ten (10) shipments, and C2 represents Delivery Rule attribute of Supplier2 directing that Supplier2 makes two (2) deliveries to Store2 for every delivery to Store1.

Similarly, base constraints of Entity 510 representing Supplier1 are formulated as:

C3: A1+A2<=5;

C4: A1+2*A2<=5,

wherein C3 represents Maximum Weekly Delivery Capacity attribute of Supplier1 having the value of five (5) shipments, and C4 represents Delivery Rule attribute of Supplier1 directing that Supplier1 makes two (2) deliveries to Store1 for every delivery to Store2.

The base constraints of Entity 530 representing Store1 are formulated as:

C5: Y1+Y2<=14;

C6: Y1>=1;

C7: Y2>=1,

wherein C5 represents Maximum Weekly Acceptance Capacity attribute of Store1 having the value of fourteen (14) shipments, and C6 and C7 collectively represent Delivery Rule attribute of Store1 directing that Store1 orders at least one (1) weekly shipment from each supplier, Supplier1 510 and Supplier2 520.

The base constraints of Entity 540 representing Store2 are formulated as:

C8: Z1+Z2<=10;

C9: Z1>=1;

C10: Z2>=1,

wherein C8 represents Maximum Weekly Acceptance Capacity attribute of Store2 having the value of ten (10) shipments, and C9 and C10 collectively represent Delivery Rule attribute of Store2 directing that Store2 orders at least one (1) weekly shipment from each supplier, Supplier1 510 and Supplier2 520.

Further base constraints regarding entities 510, 520, 530, and 540 are formulated as:

C11: A1−Y1=0;

C12: B1−Y2=0;

C13: A2−Z1=0;

C14: B2−Z2=0,

wherein C11 refers to that, within a pair of Supplier1 and Store1, the number of weekly shipments sent by Supplier1 is equal to the number of weekly shipment received by Store1, as represented by two entities 510, 530 at both ends of AY arrow, C12 refers to that, within a pair of Supplier2 and Store1, the number of weekly shipments sent by Supplier2 is equal to the number of weekly shipment received by Store1, as represented by two entities 520, 530 at both ends of BY arrow, C13 refers to that, within a pair of Supplier1 and Store2, the number of weekly shipments sent by Supplier1 is equal to the number of weekly shipment received by Store2, as represented by two entities 510, 540 at both ends of AZ arrow, and C14 refers to that, within a pair of Supplier2 and Store2, the number of weekly shipments sent by Supplier2 is equal to the number of weekly shipment received by Store2, as represented by two entities 520, 540 at both ends of BZ arrow.

The optimal routes under constraints of aforementioned C1 through C14 are calculated as:

A1=Y1=3;

B1=Y2=1;

A2=Z1=1;

B2=Z2=8;

P=1000+2000*8+2000*3+3000*1+5000*3+4000+5000+6000*8=98000,

wherein the sum of profits P is 98000 as above and respective profits for entities 510, 520, 530, and 540 are 9000, 17000, 19000, and 53000, respectively. P=98000 is referred to as Objective value indicating the value is a maximum that can be obtained under the current constraints. For constraints C1 through C10 having their inequalities as linear equations, slack variables are created by the tool to solve the optimization problem. Further the tool optionally performs sensitivity analysis to shown a range of values for respective constraints within the linear programming. When a constraint has a value out of the range set for the constraint, then the tool cannot generate a solution, and accordingly a request to change may be examined against a range set for the constraint corresponding to the request.

While the entities 510, 520, 530, and 540 make deliveries according to the optimal route as calculated above, entity 510 representing Store1 made a request to change the optimal route such that Store1 receives four (4) shipments from entity 520 representing Supplier2. Profit formulation and constraints C1 through C14 are the same as the optimal route, but the request is formulated into one or more additional constraints as:

C15: Y2=4,

wherein C15 represents the request of Store1 to receive four (4) shipments from Supplier2.

A new routes under the new set of constraints C1 through C15 are calculated as:

A1=Y1=3;

B1=Y2=4;

A2=Z1=1;

B2=Z2=2;

P=1000*4+2000*2+2000*3+3000*1+5000*3+4000*4+5000+6000*2=65000,

wherein the sum of profits P of the new route is 65000 and respective profits for entities 510, 520, 530, and 540 are 9000, 8000, 31000, and 17000, respectively.

The routing engine performs impact analysis for the new routes and determines that changing the optimal route to the new route will cause no change in profit for entity 510 representing Supplier1, a loss of 9000 for entity 520 representing Supplier2, a gain of 12000 for entity 530 representing Store1, which is the requesting entity, and a loss of 36000 for entity 540 representing Store2.

The routing engine then calculates incentives for the requesting entity, entity 530 representing Store1, to pay out to the affected entities. The incentives are devised to mitigate or compensate for respective losses of the affected entities as being suffered by the new routes such that the affected entities may accept the new routes more readily within the routing optimization system. Further, the incentives may be adjusted based on Participation History of the requesting entity.

Acceptance Rate respective to entities may be calculated, by user of attributes Participation History, Transaction Record, associated with the entity, in a percent rate resulting from a number of changes accepted by the entity divided by a number of change requests made to the entity times one hundred, that is:

$$Acceptance Rate = \frac{NumAcceptances}{NumRequests} * 100$$

Discount Rate that determines how much of the actual loss should be offered as incentive to the affected entities by the requesting entity may be calculated as a function of Acceptance Rate as:

| Acceptance Rate | Discount Rate |
|---|---|
| 80-100% | 50% |
| 60-79% | 40% |
| 40-59% | 30% |
| 30-39% | 20% |
| 20-29% | 10% |
| Less than 20% | No Discount |

In the example of the new route, the affected entities 520 and 540, respectively representing Supplier2 and Store2 will be offered with the respective incentives as calculated by the routing engine based on the Acceptance Rate of the requesting entity 530 representing Store1 rather than the actual amount of loss caused by the new routes. Wherein Acceptance Rate of the requesting entity 530 representing Store1 is greater than eighty (80), which indicates that Store1 has accepted more than eighty percent of similar changes made by other in the past, Store1 will get fifty (50) percent discount with the incentive amount to pay out as:

IncentiveForAffectedEntity=Actual Change in Profit*(1−Discount Rate)

IncentiveForStore2=(53000−17000)*(1−0.50)=18000

IncentiveForSupplier2=(17000−8000)*(1−0.50)=4500

The routing engine presents the requesting entities with the new routes and the discounted incentives to pay out to affected entities 520, 540 in block 3401 of FIG. 4C, thus the requesting entity may decide to revoke the request in case the incentives to pay out, which is a cost of change for the requesting entity, is not desirable in comparison to the reasons for the change request. In another embodiment of the present disclosure, the requesting entity may negotiate the respective incentives directly with the affected entities. The requesting entity may make a new request that will cost the requesting entity less for the change, subsequent to the revocation of the request, which will be processed by the routing engine in another cycle of the described process.

Certain embodiments of the present invention may offer various technical computing advantages, including increasing the computing efficiency of computing environments shared amongst entities subscribing to a routing optimization system wherein implemented as a cloud service component, and enabling coordinated and centralized private communication channels and access to synchronized database by the entities. Accordingly, the entities may utilize computing resources more sparingly and more efficiently than when the entities attempt to adjust routings based on entity-to-entity communication without the routing optimization system. Implementing certain embodiments of the present invention as a cloud computing component can enhance the performance of the routing optimization system and the entities as a whole, as the coordinated communication between entities are facilitated by the routing optimization system and respective agent program running on the entities, optimal routing and computationally effective adjustment to an existing route may be achieved. Specifically, logistical challenges met by respective entities may be singlehandedly taken care of the routing optimization system and supporting equipment/assisting tools such as radio communication devices, global positioning systems (GPSs), and/or routing optimization entity agent programs. Another advantage of certain embodiments is that compared with the traditional logistics problem solving, in certain embodiments of the present invention, because the entities are facilitated with real-time analyses of a request to make change to a previous logistic solution and of associated cost of a requested change, as well as a real-time feasibility screening of the requested change, the entities can interactively make decisions based on outcomes of the analyses. In this specification, the term “real-time” indicates of or relating to a computing technology in which input data is processed by one or more processor subject to a minimal time period delay attributable to computer processing delay such that a response to the input data is generated within respective time frames mandated by tasks for instantaneous responses, as in an anti-lock brake system (ABS) of motor vehicles.

As discussed above, certain embodiments of the present invention utilizes computing resources more efficiently in real-time logistical problem solving by use of coordinated communication network and centralized analyses and processes. Thus, certain embodiments of the present invention are particularly relevant to increasing the efficiency and communications of services provided from a cloud computing environment.

FIGS. 6-8 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system 12 in cloud computing node 10 is shown in the form of a general-purpose computing device. The components of computer system 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

One or more program 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of the routing optimization system 110 of FIG. 1. Program modules 42 generally carry out the functions and/or methodologies of embodiments of the invention as described herein, as shown in the cognitive API 115, a program managing the routing optimization database 120, and the routing engine 130 of FIG. 1.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

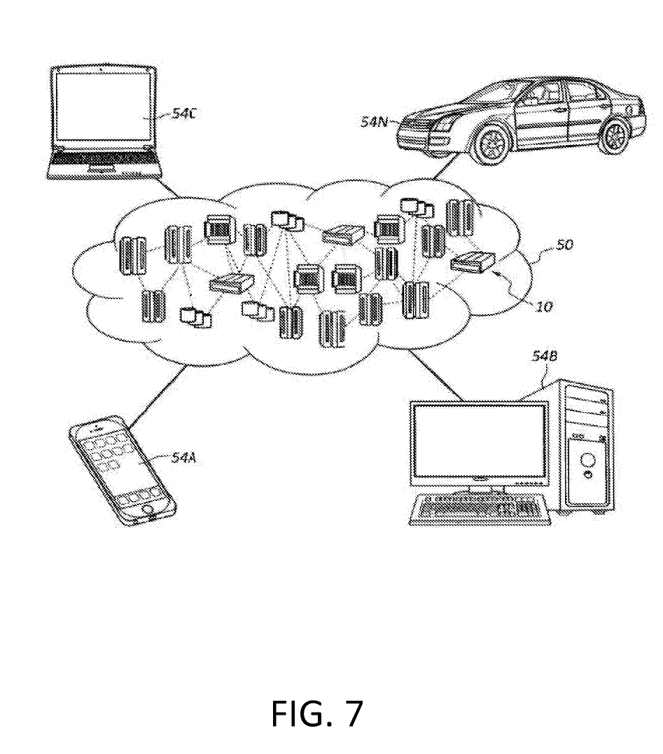

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

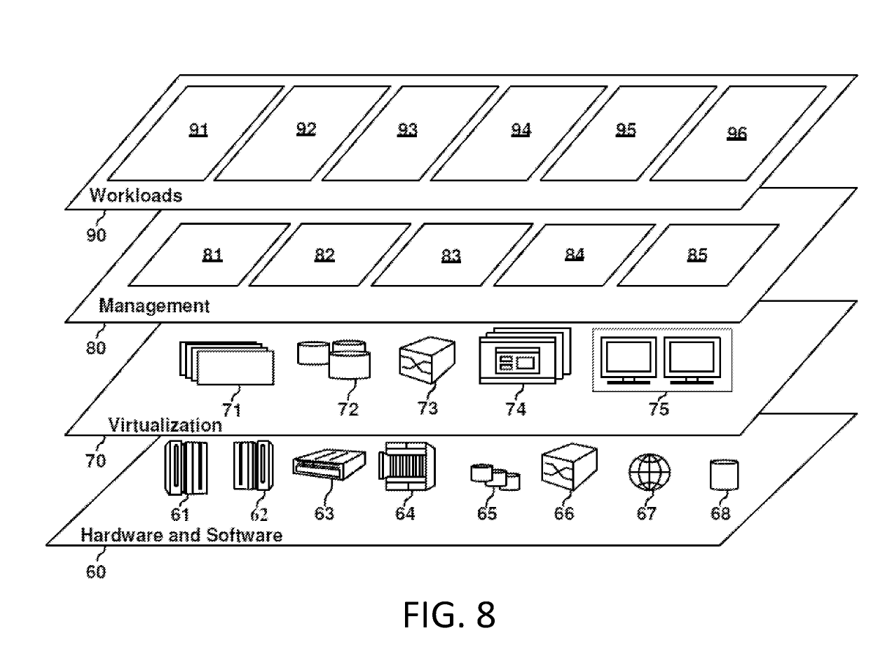

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and various processing components of a routing optimization system 96 as described herein. The processing components 96 can be understood as one or more program 40 and program modules 42 described in FIG. 7.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer-implemented method for adjusting a delivery route by use of incentives, comprising:
storing, by one or more processor, the delivery route in a routing optimization database by a routing optimization system comprising a routing engine and the routing optimization database comprising a first set of constraints, the delivery route for two or more entities based on the first set of constraints respectively associated with the entities, wherein the entities represented by respective entity program subscribe to a routing service provided by the routing optimization system running on a computer, wherein the delivery route is optimized for a target criteria determined as a function of one or more criteria constraints selected from the first set of constraints;
receiving, by the one or more processor, via a communication channel, a request to change the delivery route from a first entity program corresponding to a requesting entity of the entities;
updating, by the one or more processor, the routing optimization database with a new set of constraints comprising the first set of constraints, and one or more additional constraints and zero or more replacement constraints as formulated corresponding to the request;
storing, by the one or more processor, in the routing optimization database, a new route for the entities as generated based on the new set of constraints;
storing, by the one or more processor, in the routing optimization database, respective impact measurement for each entity of the entities, as respectively affected by the new route in terms of the criteria constraints, as analyzed by the routing engine;
storing, by the one or more processor, in the routing optimization database, respective incentive amount for the each entity to be paid by the requesting entity to the each entity on condition of accepting the new route, as calculated by the routing engine;
receiving, by the one or more processor, respective response from the each entity affirming that the each entity accepts the new route and the respective incentive amount, responsive to sending the each entity the new route and the respective incentive amount, subsequent to agreeing by the requesting entity to pay the respective incentive amount to the each entity on the condition; and,
storing, by the one or more processor, the new route in the routing optimization database for deploying the new route for future deliveries performed by the entities of the routing optimization system.

2. The computer-implemented method of claim 1, said storing the respective impact measurement comprising:
instantiating, by the one or more processor, the respective impact measurement stored in the routing optimization database with respective loss of the entities caused by the new route, wherein the respect loss is equal to a first profit using the delivery route subtracted by a second profit using the new route for respective entities, wherein each affected entity has the respective loss that is a positive value, wherein the criteria constraints is a profit attribute corresponding to each entity in the routing optimization database, and wherein the target criteria is a sum all respective profit of the entities.

3. The computer-implemented method of claim 2, said storing the respective incentive amount comprising:
ascertaining, by the one or more processor, a discount rate (DCR) applicable to the requesting entity as determined by the routing optimization system, wherein the DCR stored in the routing optimization database has a fraction within a range of [0, 0.50]; and
assigning, by the one or more processor, in the routing optimization database, the respective incentive amount for each affected entity with a value equal to the respective loss multiplied by (1−DCR).

4. The computer-implemented method of claim 3, wherein the routing optimization system, by the one or more processor, determines the DCR for the each entity according to an acceptance rate of the each entity, which indicates a percentage rate of the each entity accepting previous requests made by other entities to change the delivery route in comparison to a total number of requests proffered to the each entity.

5. The computer-implemented method of claim 4, wherein the routing optimization system, by the one or more processor, determines the DCR as fifty percent (0.5) for a first entity of the entities having the acceptance rate greater than eighty percent, as forty percent (0.4) for a second entity of the entities having sixty to seventy-nine percent of the acceptance rate, as thirty percent (0.3) for a third entity of the entities having forty to fifty-nine percent of the acceptance rate, as twenty percent (0.2) for a fourth entity of the entities having thirty to thirty-nine percent of the acceptance rate, as ten percent (0.1) for a fifth entity of the entities having twenty to twenty-nine percent of the acceptance rate, and as zero (0) for a sixth entity of the entities having the acceptance rate less than twenty percent.

6. The computer-implemented method of claim 2, said receiving the respective response comprising:
ascertaining, by the one or more processor, that the requesting entity agrees to pay the respective incentive amount for the new route to be accepted by the each affected entity, by sending, to the first entity program, a first message comprising the respective incentive amount to the each affected entity to facilitate the new route and by receiving, from the first entity program, a confirmation by the requesting entity not to revoke the request as associated with the respective incentive amount;
sending, by the one or more processor, to respective entity program, a respective incentive message comprising the new route and the respective incentive amount for the each affected entity;
receiving, by the one or more processor, from the respective entity program, the respective response agreeing with the respective incentive message that the each entity accepts the new route and the respective incentive amount; and
determining, by the one or more processor, that each entity accept the new route, with the respective incentive in case for the each affected entity.

7. The computer-implemented method of claim 1, wherein the routing optimization system further comprises a cognitive application program interface (API) that communicates with the respective entity program in real-time.

8. A computer program product comprising:
a computer readable storage medium readable by one or more processor and storing instructions for execution by the one or more processor for performing a method for adjusting a delivery route by use of incentives, comprising:
generating, by the one or more processor, the delivery route for two or more entities based on constraints respectively associated with the entities, wherein the entities subscribe to a routing optimization system executed by the one or more processor, the routing optimization system comprising a routing engine and the constraints, wherein the delivery route is optimized for a target criteria determined as a function of one or more criteria constraints selected from the constraints;
receiving a request to change the delivery route from a requesting entity of the entities;
formulating the received request into one or more additional constraints and updating the constraints of the routing optimization system with the additional constraints;
generating a new route for the entities based on the updated constraints;
analyzing respective impact of the generated new route to the entities in terms of the criteria constraints, resulting in respective impact measurement for each affected entity of the entities;
calculating respective incentive for the each affected entity to be paid by the requesting entity to the each affected entity on condition of accepting the new route;
collecting respective response from the each affected entity that the each affected entity accepts the new route and the respective incentive, wherein the requesting entity agrees to pay the respective incentive to the each affected entity on the condition; and,
deploying the new route for future deliveries performed by the entities of the routing optimization system.

9. The computer program product of claim 8, said analyzing comprising:
instantiating the respective impact measurement with respective loss of the entities caused by the new route, wherein the respect loss is equal to profit using the delivery route subtracted by profit using the new route for respective entities, wherein the each affected entity has the respective loss that is a positive value, wherein the criteria constraints is respective profit of the entities, and wherein the target criteria is a sum all respective profit of the entities.

10. The computer program product of claim 9, said calculating comprising:
ascertaining a discount rate (DCR) applicable to the requesting entity as determined by the routing optimization system, wherein the DCR is a fraction within a range of [0, 0.50]; and
assigning the respective incentive for each affected entity with a value equal to the respective loss multiplied by (1−DCR).

11. The computer program product of claim 10, wherein the routing optimization system determines the DCR for an entity in the entities according to an acceptance rate of the entity, which indicates a percentage rate of the entity accepting a previous request made by another entity to change the delivery route in comparison to a total number of requests proffered to the entity.

12. The computer program product of claim 11, wherein the routing optimization system determines the DCR as fifty percent (0.5) for the entity having the acceptance rate greater than eighty percent, as forty percent (0.4) for the entity having sixty to seventy-nine percent of the acceptance rate, as thirty percent (0.3) for the entity having forty to fifty-nine percent of the acceptance rate, as twenty percent (0.2) for the entity having thirty to thirty-nine percent of the acceptance rate, as ten percent (0.1) for the entity having twenty to twenty-nine percent of the acceptance rate, and as zero (0) for the entity have the acceptance rate less than twenty percent.

13. The computer program product of claim 9, said collecting comprising:
ascertaining that the requesting entity agrees to pay the respective incentive for the route to be accepted by the each affected entity, by submitting the calculated respective incentive to the each affected entity and by receiving a confirmation from the requesting entity not to revoke the request as associated with the respective incentive;
presenting the new route and the respective incentive for the each affected entity to the entities for the respective response; and
determining that each of the entities accept the new route, with the respective incentive in case for the each affected entity.

14. The computer program product of claim 8, wherein the routing optimization system comprises a routing optimization database and the routing engine, wherein the routing optimization database, storing data of the routing optimization system comprising the constraints, is coupled to the routing engine performing said adjusting the delivery route, and wherein the routing optimization system further comprises a cognitive application program interface (API) that communicates with the entities in real-time.

15. A system comprising:
a memory;
one or more processor in communication with memory; and
program instructions executable by the one or more processor via the memory to perform a method for adjusting a delivery route by use of incentives, comprising:
generating, by the one or more processor, the delivery route for two or more entities based on constraints respectively associated with the entities, wherein the entities subscribe to a routing optimization system executed by the one or more processor, the routing optimization system comprising the constraints, wherein the delivery route is optimized for a target criteria determined as a function of one or more criteria constraints selected from the constraints;
receiving a request to change the delivery route from a requesting entity of the entities;
formulating the received request into one or more additional constraints and updating the constraints of the routing optimization system with the additional constraints;
generating a new route for the entities based on the updated constraints;
analyzing respective impact of the generated new route to the entities in terms of the criteria constraints, resulting in respective impact measurement for each affected entity of the entities;
calculating respective incentive for the each affected entity to be paid by the requesting entity to the each affected entity on condition of accepting the new route;
collecting respective response from the each affected entity that the each affected entity accepts the new route and the respective incentive, wherein the requesting entity agrees to pay the respective incentive to the each affected entity on the condition; and,
deploying the new route for future deliveries performed by the entities of the routing optimization system,
wherein the routing optimization system comprises a routing optimization database and a routing engine, wherein the routing optimization database, storing data of the routing optimization system comprising the constraints, is coupled to the routing engine performing said adjusting the delivery route, and wherein the routing optimization system further comprises a cognitive application program interface (API) that communicates with the entities in real-time.

16. The system of claim 15, said analyzing comprising:
instantiating the respective impact measurement with respective loss of the entities caused by the new route, wherein the respect loss is equal to profit using the delivery route subtracted by profit using the new route for respective entities, wherein the each affected entity has the respective loss that is a positive value, wherein the criteria constraints is respective profit of the entities, and wherein the target criteria is a sum all respective profit of the entities.

17. The system of claim 16, said calculating comprising:
ascertaining a discount rate (DCR) applicable to the requesting entity as determined by the routing optimization system, wherein the DCR is a fraction within a range of [0, 0.50]; and
assigning the respective incentive for each affected entity with a value equal to the respective loss multiplied by (1−DCR).

18. The system of claim 17, wherein the routing optimization system determines the DCR for an entity in the entities according to an acceptance rate of the entity, which indicates a percentage rate of the entity accepting a previous request made by another entity to change the delivery route in comparison to a total number of requests proffered to the entity.

19. The system of claim 18, wherein the routing optimization system determines the DCR as fifty percent (0.5) for the entity having the acceptance rate greater than eighty percent, as forty percent (0.4) for the entity having sixty to seventy-nine percent of the acceptance rate, as thirty percent (0.3) for the entity having forty to fifty-nine percent of the acceptance rate, as twenty percent (0.2) for the entity having thirty to thirty-nine percent of the acceptance rate, as ten percent (0.1) for the entity having twenty to twenty-nine percent of the acceptance rate, and as zero (0) for the entity have the acceptance rate less than twenty percent.

20. The system of claim 16, said collecting comprising:
ascertaining that the requesting entity agrees to pay the respective incentive for the route to be accepted by the each affected entity, by submitting the calculated respective incentive to the each affected entity and by receiving a confirmation from the requesting entity not to revoke the request as associated with the respective incentive;
presenting the new route and the respective incentive for the each affected entity to the entities for the respective response; and
determining that each of the entities accept the new route, with the respective incentive in case for the each affected entity.
